(19) United States
(12) Patent Application Publication
(10) Pub. No.: US 2006/0232040 A1
(43) Pub. Date: Oct. 19, 2006

(54) Scooter Bike

(76) Inventor: Isaac Franco, Taylorsville, UT (US)

Correspondence Address: GEOFFREY E. DOBBIN, PATENT ATTORNEY, 4278 SOUTH 6220 WEST, WEST VALLEY CITY, UT, 84128-6501, US

(21) Appl. No.: 11/279,721

(22) Filed: Apr. 13, 2006

Related U.S. Application Data
(60) Provisional application No. 60/670,865, filed on Apr. 13, 2005.

(51) Int. Cl. B62K 17/00

(52) U.S. Cl. 280/278

(57) ABSTRACT

The present invention is a vehicle combining a scooter with a bicycle. As such, it comprises an adjustable scooter frame with a seat and drive mechanism of a bicycle. The drive mechanism is positioned above the scooter platform and forward of the post holding the seat so as to provide a more ergonomic situation for the user. Other means of locomotion are also provided.

### CROSS-REFERENCES TO RELATED APPLICATIONS

The present application is a non-provisional perfection of prior filed Provisional Application 60/670,865, filed Apr. 13, 2005.

### FIELD OF THE INVENTION

The present invention relates to the field of vehicles for transportation and more particularly relates to a vehicle that is a scooter and bicycle combination.

### BACKGROUND OF THE INVENTION

The invention provides a much-needed improvement to scooters and shows a versatile use of a bicycle crankset drive applied to the scooter as the drive mechanism when the scooter is in bicycle mode. The scooter bike is a maneuverable scooter that includes a frame supporting body suspended between two wheels, having a rear fork and supporting wheel with a driven freewheel attached to it, a front fork steerable mechanism and supporting wheel, a middle standing deck with a bicycle drive crankset mechanism, a continuous endless chain linked to the driven freewheel and the drive crankset, two folding pedals for the rider to drive the crank mechanism and advance the scooter forward, and an adjustable seat post assembly.

Relevant prior art includes: U.S. Patent Application Publication US 20020185836 A1 Dec. 12, 2002 to Irlbacher; U.S. Patent Application Publication US 20020121754 A1 Sep. 5, 2002 to Nal; U.S. Patent Application Publication US 20030193160 A1 Oct. 16, 2003 to Mehmet; U.S. Patent Application Publication US 2004/0239064 A1 Dec. 2, 2004 to Clifton; and, U.S. Patent Application Publication US 20040004341 A1 Jan. 8, 2004 to Carr. Many attempts have been made in the past to create a scooter that can be propelled without the need of the rider to touch the ground to provide a more continuous motion and travel longer distance. However, prior attempts are awkward to use and do not achieve desired comfort and speeds as a bicycle.

### SUMMARY OF THE INVENTION

The present invention departs from designs in the prior art in that it uses a regular bicycle crankset and sprocket as a driving mechanism and provides a more efficient means of propulsion. It also provides better comfort because the position of the crankset allows the rider to sit down while pedaling as in a bicycle or pushing as in a scooter. The rider can also sit down to rest while in motion when it is in scooter mode. The use of foldable pedals makes the scooter convertible into bicycle or scooter. When the pedals are folded, the pedals do not protrude much making it safe to push the scooter with your foot because the pedal is folded out of the way. When the pedal is open, the scooter can be used as a bicycle. The pedals can be folded or opened while in motion, by hand or by a small push and kick. The rider does not have to stop to convert the scooter. It can be used with pneumatic or solid tires. It has a modern look and can travel a long distance just as a bicycle. Takes less space than a regular bicycle to store due to the folding pedals and mini handle grip.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of my scooter bike showing its general features.

FIG. 2 is a side view showing how the crankset mechanism and supporting frame is connected.

FIG. 3 is a sectional view of the scooter showing the open pedals for operating the scooter in bicycle mode.

FIG. 4 is a rear view of the scooter showing the pedals folded to operate in scooter mode.

FIG. 5 is a sectional aerial view of the rear wheel assembly.

### DETAILED DESCRIPTION OF THE PREFERRED EMBOPDIMENT

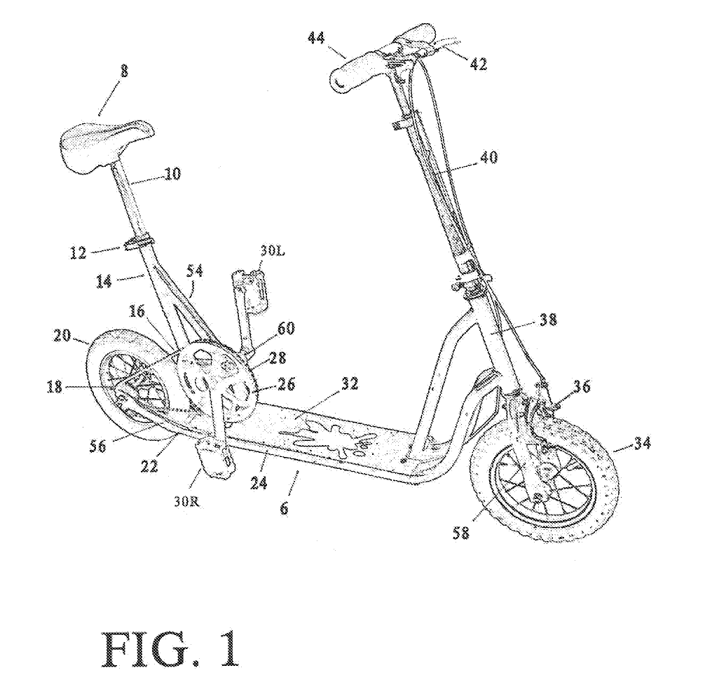

With reference now to the drawings, the preferred embodiment of the scooter bike is herein described. It should be noted that the articles “a”, “an” and “the”, as used in this specification, include plural referents unless the content clearly dictates otherwise. With reference to FIG. 1, Scooter bike 6 essentially comprises a scooter frame 24 having a front handle cylinder 38 as part of the main frame of the body and an adjustable extension handle post 40 secured in said front handle cylinder 38. Due to the high speeds that the scooter bike 6 can achieve it is provided with rear brakes 22 and front brakes 36 activated by right brake lever handle 42R and left brake lever handle 42L respectively, which at the same time are supported at the handle bar grip 44 by means of clamps just as a bicycle. Handle bar 44 is affixed to the extension handle post 40 by means of welding, clamps or compression. The middle section of the frame structure contains a deck 32 for the rider to stand up when operating the scooter in scooter mode. A crankset 60 and front sprocket 28 are mounted on a crank housing 52 to provide the driving mechanism for the scooter bike 6. The crank housing 52 is supported by an upright supporting crank post 46, a cross-supporting crank structure member 50, and a diagonal supporting crank structure 54. The folding pedals 30A and 30B, which are commercially available from STRIDA store, are affixed to the crankset 60. On the front sprocket 28 a chain cover 26 is secured to prevent foreign matter getting into chain 16. Seat post 14 provides a mean for supporting the weight of the rider as well as a mean for inserting a seat post extension 10 that can be adjusted to the height and liking of the rider. Seat 8 is secured to the seat post extension 10 by means of clamps and it is manufactured of soft materials to provide comfort to the rider while seated. At the rear portion of frame 24 a rear fork 56 is provided to support the axle of rear wheel 20, which is coaxially connected to a rear drive sprocket 18, said drive sprocket being rotatable with said axle. Chain 16 is wrapped around and linked to the drive rear sprocket 18 and the front sprocket 28. When a downward force is applied to the pedals 30R and 30L the crankset 60 rotates driving the drive rear sprocket 18 and the rear wheel 20 in forward motion thus propelling the rider in the same manner than a bicycle.

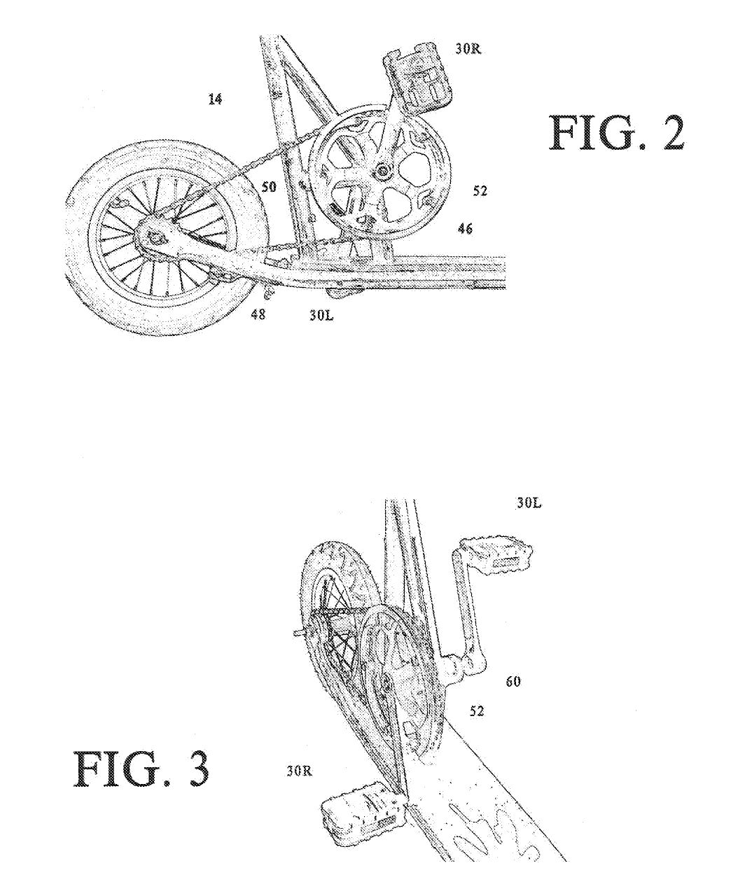

FIG. 2 is a side view showing the cross plate 48 as the support for the seat post 14 and how the crank housing 52 is connected to the supporting structure members. The crank housing 52 is supported by three frame structures for stability and strength. Said crank housing 52 is supported at the bottom by the upright supporting crank post 46, by the diagonal supporting crank structure 54 at the top and by the cross-supporting crank structure member 50 at the back. When downward force is applied to the pedals 30R and 30L in alternating motion to propel the rear drive sprocket 18 said structures maintain the crankset 60 and the crank housing 52 in firm and undisturbed position in the same way than in bicycles. The height of the pedals from the ground up is the same of that in bicycles. The rider can enjoy the same ride in the scooter bike as if he/she were on a bicycle.

FIG. 3 is a sectional view of the scooter showing the open pedals for operating the scooter in bicycle mode. The versatile and strategic positioning of crankset 60 and crank housing 52 on deck 32 and the use of the patented folding pedals make the scooter bike convertible to scooter or bicycle. The rider can open the folded pedals 30R and 30L by hand with a gentle outward pull or by simply pushing or kicking the pedal in an outward direction. When the pedals 30R, 30L are open, the scooter is in bicycle mode and can be ridden as a regular bicycle. There is no need for the rider to stop to open the pedals. The rider can open said pedals while in motion. To close the pedals 30R, 30L the rider can push the pedals inward by hand and push down to a folded position; or if desired, the riders can do this by foot by pushing in the pedal 30R or 30L with the foot then down. The rider can interchange to scooter or bicycle use while in motion, thus giving the rider a more exciting ride.

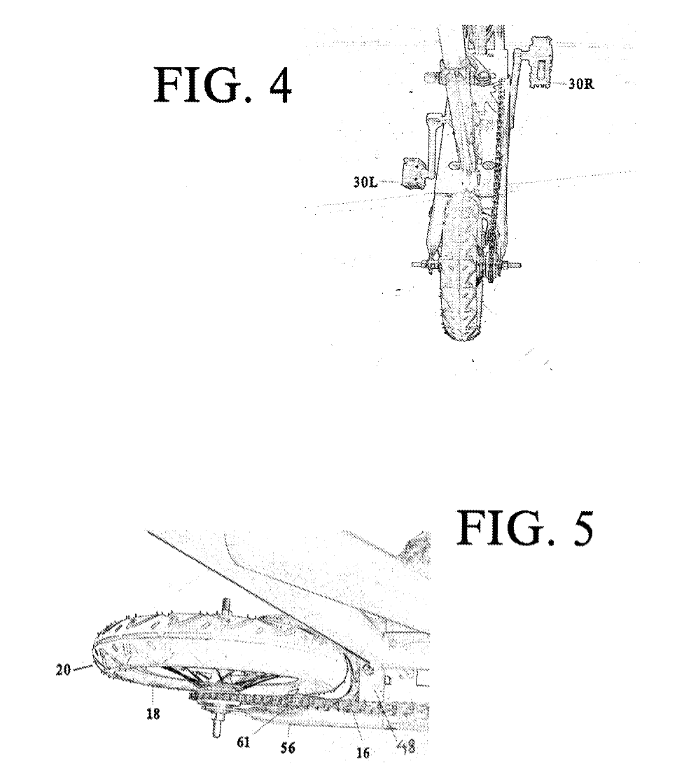

FIG. 4 is a sectional perspective rear view of the scooter showing the pedals 30R and 30L folded to operate in scooter mode. The rider can safely push the scooter with the foot without hitting his/her leg on the pedals 30R, 30L. When said pedals 30R, 30L are in folded position, the protuberance is minimal making it safe for the rider to push the scooter 6 in a normal and safe way as in any scooter.

FIG. 5 is a sectional aerial view showing the interaction of the rear wheel 20, the drive rear sprocket 18 and the endless chain 16. The rear fork 56 has an indentation 61 at the spot where the chain travels on the right section of the fork. This indentation 61 allows the chain 16 to travel freely without touching the body of the frame 24. As forward and downward force is applied to pedals 30R, 30L (FIG. 3) in alternating motion, chain 16 is activated and put into movement by the front sprocket 28 (FIG. 1) transferring motion to the rear sprocket drive 18 said drive being affixed to the rear wheel 20 thus propelling the scooter in a forward direction. If the force is applied in a backward and downward direction, the chain 16 will transfer motion in a backward direction to the rear drive sprocket 18, but the mechanical force will not be transferred to the rear wheel 20 because the rear drive sprocket propels only in forward direction being a free wheel sprocket.

The rider of the scooter bike 6 operates the unit in scooter mode by pushing in each folding pedal 30R, 30L by hand or foot, then slightly push down. The rider then stands a top of deck 32 with one foot, and the other foot on the ground. The rider grabs the handle bar grip 44 and then pushes off with the one foot on the ground thus pushing the scooter 6 in a repetitive motion until the rider decides to place the other foot on deck 32 and coast with the momentum already reached and lets the speed eventually decrease; or when needed the rider can thrust the speed again by repeating the pushing motion. The rider can sit on seat 8 while pushing with the foot or coasting. The rider can convert the scooter 6 into a bicycle by simply pushing outward the folded pedals 30R and 30L by hand or by foot. This can be done while the scooter 6 is stopped or in motion. With the pedals 30R and 30L open, the scooter is in bicycle mode. In bicycle mode the rider sits on seat 8, grabs handle bar grip 44, and then places one foot on pedal 30R or 30L. The other foot is used to hold the weigh of the rider by keeping it on the ground. When ready to move, the rider slightly pushes the scooter bike forward with the foot that is on the ground and simultaneously he/she pushes downward and forward the foot that is on pedal 30R or 30L. Immediately the foot that was on the ground is placed on the other pedal. The pedaling motion is an alternate downward and forward force applied to the crankset 60 to create thrust and transfer the mechanical force via chain 16 to the rear drive sprocket 18 and the rear wheel 20. The scooter bike 6 is a steerable unit, and it can be converted to either use while in motion depending on the liking of the rider. The scooter bike 6 can achieve same speeds as in bicycles. A set of front brakes 36 and rear brakes 22 are provided so the rider can control the speed and maneuverability of the unit.

Alternatively, the use of folding pedals 30R, 30L which are readily accessible in the market can be substituted with other means that can be collapsible or attached with quick release mechanisms or any means that can be removed quickly or make the pedals to be out of the way to make it safe for foot scooting. The shaft for the crankset 60 alternatively can be built longer to give a wider deck 32 and allow the scooter bike 6 to hold an adult person or just to give more room to the width of the deck 32.

The scooter bike 6 is represented in all the drawings as a wheel unit. Alternatively, it may be equipped with virtually any conventional type of either rolling or sliding surface contact means, e.g. inline or other wheel skates, solid or pneumatic wheels, skis, ice skates, etc.

The strategic positioning of the crankset 60 where it is placed in a position at adequate height above the deck 32 and away from the rear wheel 20. Alternatively, this can be positioned higher or lower, closer or farther away from the rear wheel 20. The positioning of the crankset 60 can be anywhere in the middle section of the deck 32 or middle section of the frame 24. Alternatively, the indentation of the rear fork 56 that allows the chain 16 to run undisrupted can be formed by other means of shaping the fork wider to allow space for chain 16 to run freely without obstruction. The crankset supporting structure members can be alternatively made with different mix of materials such steels, aluminum or alloys. The structure positioning of these can differ depending on the strength desired.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A vehicle comprising:
a. A front pole having a first end connected to a steering means and a forked second end into which is positioned a front wheel;
b. A vehicle frame further comprising:
i. connection means coaxial with and surrounding the front pole;
ii. a floor platform from which the connection means protrude; and
iii. a rear wheel, positioned on a side opposite the connection means;
c. a rear pole extending from the floor platform and terminating in a seating means;
d. a cranking propulsion means, operably connected to the rear wheel and positioned forward of the rear pole, above the floor platform; and,
e. structure securing the propulsion means to the vehicle frame.

2. The vehicle of claim 1, the cranking propulsion means further comprising:
a. A first gear, rotationally mounted upon the frame and having two offset pedals extending from opposite gear faces;
b. A second gear, mounted coaxially and fixedly on the second wheel; and
c. A looped chain, interconnecting the gears around their circumferences and simultaneously interfacing with spokes of said gears.

3. The vehicle of claim 2, the pedals being foldable into a stowed position.

4. The vehicle of claim 2, the front pole being extendable.

5. The vehicle of claim 2, the rear pole being extendable.

6. A vehicle comprising:
a. A front pole having a first end connected to a steering means and a second end having locomotion connection means;
b. A vehicle frame further comprising:
i. connection means coaxial with and surrounding the front pole;
ii. a floor platform from which the connection means protrude; and
iii. locomotion connection means, positioned on a side opposite the connection means;
c. a rear pole extending from the floor platform and terminating in a seating means;
d. locomotion means;
e. a propulsion means, operably connected to the locomotion means and positioned forward of the rear pole, above the floor platform; and,
f. structure securing the propulsion means to the vehicle frame.

7. The vehicle of claim 6, the locomotion means being selected from the set of locomotion means consisting of: wheels, blades, and skis.
